(19) United States
(12) Patent Application Publication
(10) Pub. No.: US 2026/0074110 A1
(43) Pub. Date: Mar. 12, 2026

(54) MULTILAYER CERAMIC CAPACITOR

(71) Applicant: Murata Manufacturing Co., Ltd., Nagaokakyo-shi (JP)

(72) Inventor: Kosuke ONISHI, Nagaokakyo-shi (JP)

(21) Appl. No.: 19/299,670

(22) Filed: Aug. 14, 2025

(30) Foreign Application Priority Data
Sep. 9, 2024 (JP) 2024-155227

(51) Int. Cl. H01G 4/008; H01G 4/12; H01G 4/30

(52) U.S. Cl. CPC H01G 4/008; H01G 4/30; H01G 4/1227; H01G 4/1236

(57) ABSTRACT

In a multilayer ceramic capacitor, when an internal electrode layer closest to one of outer layer portions is defined as an outermost internal electrode layer, the outermost internal electrode layer includes an internal electrode existing region and an internal electrode dividing region. The internal electrode dividing region includes a segregated region of magnesium or manganese, and a ratio B/A of a distance B in a length direction of the segregated region of magnesium or manganese relative to a distance A in the length direction of the internal electrode existing region is about 50% or more and about 75% or less.

### CROSS REFERENCE TO RELATED APPLICATIONS

This application claims the benefit of priority to Japanese Patent Application No. 2024-155227 filed on Sep. 9, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

For example, the multilayer ceramic capacitor described in Japanese Unexamined Patent Application, Publication No. 2001-237137 includes a capacitor main body made of a ceramic sintered body including a dielectric material such as barium titanate. Inside the capacitor main body, internal electrode layers made of a precious metal material such as silver or silver-palladium alloy or a base metal material such as nickel are provided with ceramic layers defining and functioning as dielectric layers interposed therebetween. The internal electrode layers are alternately extended to one end surface and the other end surface of the capacitor main body. The alternately extended first internal electrode layers and second internal electrode layers are electrically connected to external electrodes having different potentials, respectively.

The internal electrode layers of the multilayer capacitor described in Japanese Unexamined Patent Application, Publication No. 2001-237137 include a metal material, and the external electrodes include a plurality of metal components including the same metal or a metal that can be alloyed therewith, and a glass component. The external electrodes are bonded to a wiring board via an electrically conductive resin adhesive. The area occupancy ratio of the metal component relative to the cross-sectional area of the external electrode is in the range of 60% to 95%. Thus, the multilayer capacitor described in Japanese Unexamined Patent Application, Publication No. 2001-237137 can be mounted on a wiring board with high reliability at low cost without using solder.

The general multilayer ceramic capacitor as described above has room for improvement in that the dielectric layers are partially thinned, and high-temperature load reliability decreases starting from the thinned portions. In particular, among the dielectric layers in the effective layer portion, thinning of the dielectric layers due to segregation of metal may occur in the dielectric layers located near the boundary with the outer layer portion. As a result, the high-temperature load reliability of the multilayer ceramic capacitor may decrease.

### SUMMARY OF THE INVENTION

Example embodiments of the present invention provide multilayer ceramic capacitors in each of which a decrease in high-temperature load reliability is reduced or prevented.

A multilayer ceramic capacitor according to an example embodiment of the present invention includes a plurality of dielectric layers and a plurality of internal electrode layers that are laminated, a first main surface and a second main surface opposed to each other in a height direction, a first lateral surface and a second lateral surface opposed to each other in a width direction orthogonal or substantially orthogonal to the height direction, a first end surface and a second end surface opposed to each other in a length direction orthogonal or substantially orthogonal to the height direction and the width direction, an inner layer portion in which the plurality of dielectric layers and the plurality of internal electrode layers are alternately laminated, and outer layer portions sandwiching the inner layer portion between the first main surface and the second main surface, a first external electrode on the first end surface, and a second external electrode on the second end surface, in which, when an internal electrode layer of the plurality of internal electrode layers closest to one of the outer layer portions is defined as an outermost internal electrode layer, in a cross section parallel or substantially parallel to the length direction and the height direction, the outermost internal electrode layer includes an internal electrode existing region and an internal electrode dividing region, the internal electrode dividing region includes a segregated region of magnesium or manganese, and a ratio B/A of a distance B in the length direction of the segregated region of magnesium or manganese relative to a distance A in the length direction of the internal electrode existing region is about 50% or more and about 75% or less.

According to example embodiments of the present invention, it is possible to provide multilayer ceramic capacitors in each of which a decrease in high-temperature load reliability is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor according to an example embodiment of the present invention.

FIG. 2 is a cross-sectional view taken along the line 101-101 of FIG. 1.

FIG. 3 is a cross-sectional view taken along the line 102-102 of FIG. 2.

FIG. 4 is a cross-sectional view taken along the line 103-103 of FIG. 2.

FIG. 5 is a cross-sectional view taken along the line 104-104 of FIG. 2.

FIG. 6 is an enlarged view of a frame 110 in FIG. 2.

FIG. 7 is a view corresponding to FIG. 6 of a conventional multilayer ceramic capacitor.

FIG. 8A is a scanning electron microscope image of a cross section of a multilayer ceramic capacitor according to an example embodiment of the present invention.

FIG. 8B is a mapping image of magnesium in a cross section of a multilayer ceramic capacitor according to an example embodiment of the present invention.

FIG. 8C is a mapping image of manganese in a cross section of a multilayer ceramic capacitor according to an example embodiment of the present invention.

FIG. 9 is a table showing evaluation results of high-temperature load reliability.

### DETAILED DESCRIPTION OF THE EXAMPLE EMBODIMENTS

Example embodiments of the present invention will be described in detail below with reference to the drawings.

### Multilayer Ceramic Capacitors

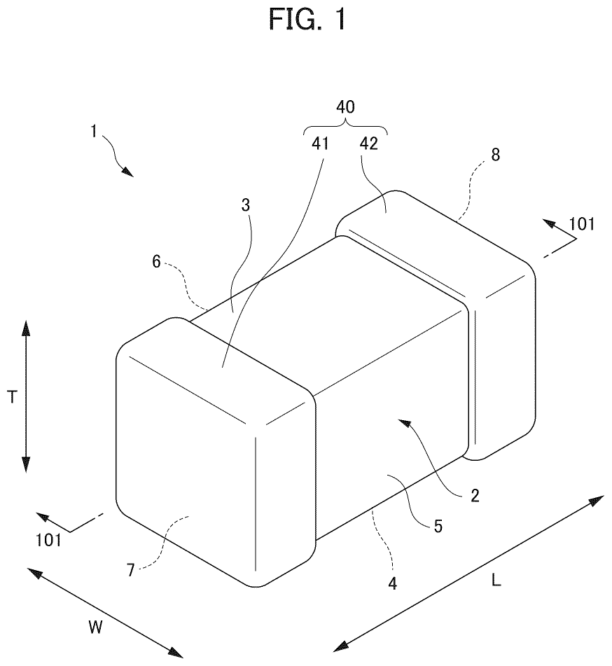

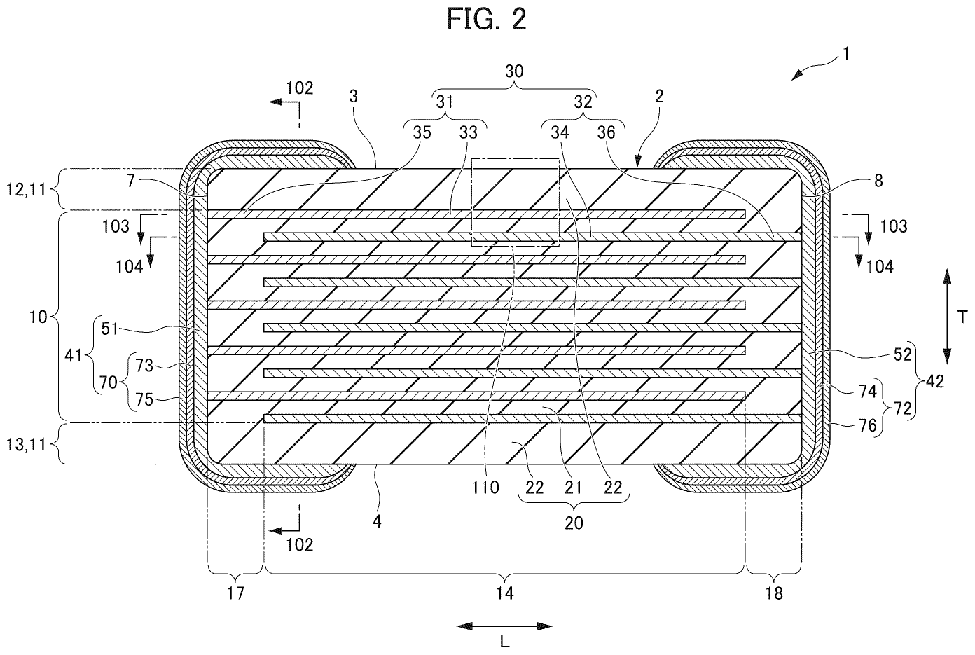

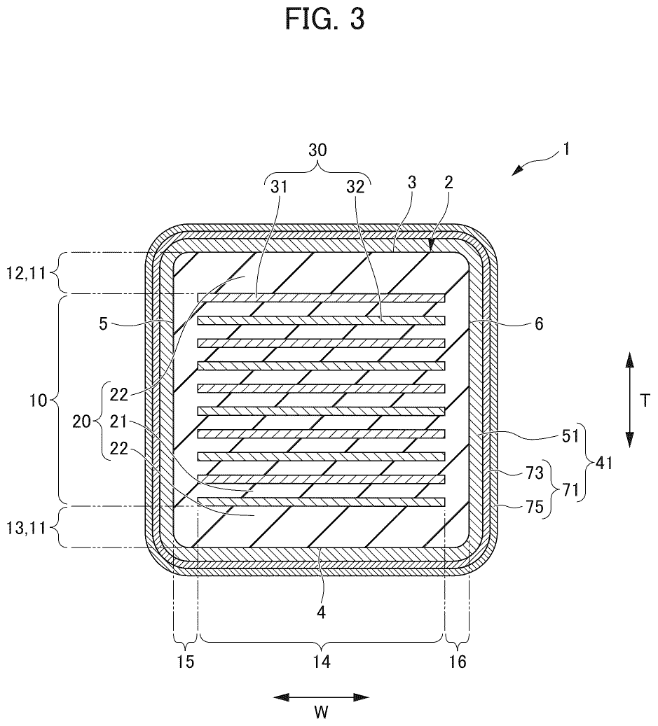

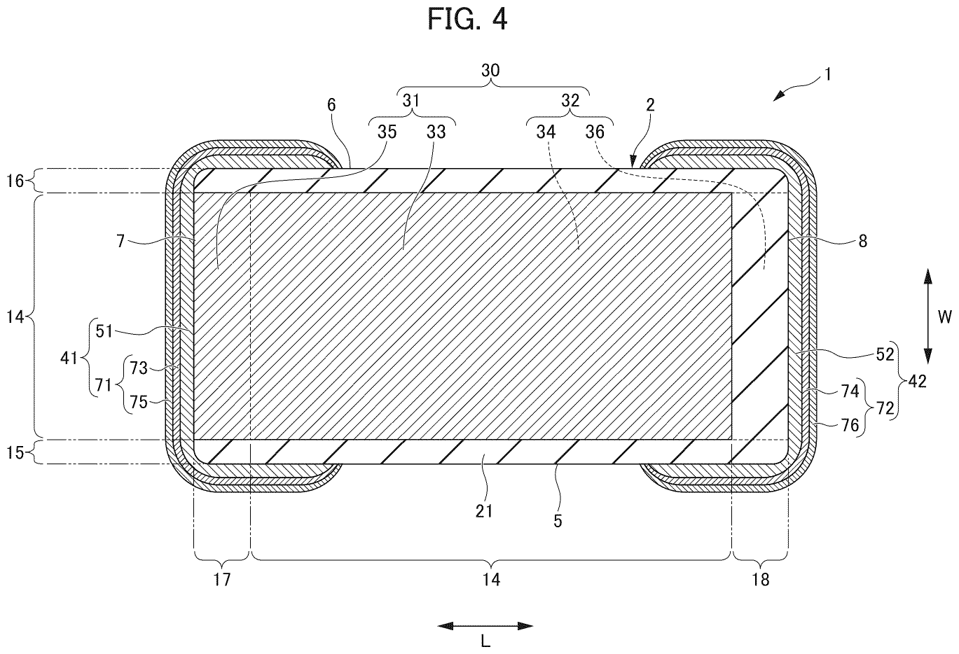

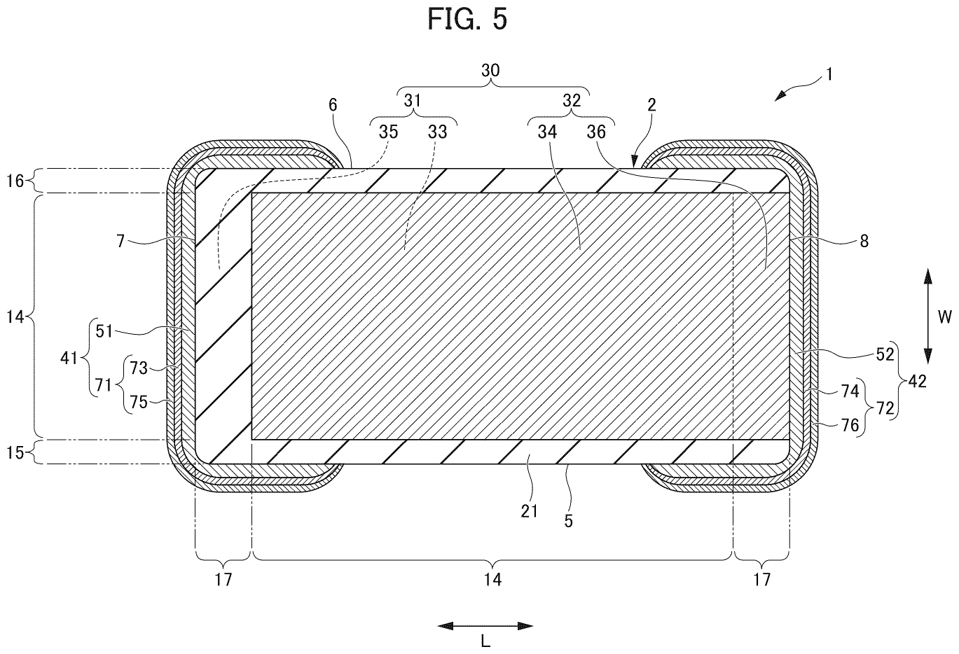

Multilayer ceramic capacitors 1 according to example embodiments of the present invention will be described with reference to the drawings. FIG. 1 is an external perspective view of the multilayer ceramic capacitor 1 according to an example embodiment of the present invention. FIG. 2 is a cross-sectional view taken along the line 101-101 of FIG. 1. FIG. 3 is a cross-sectional view taken along the line 102-102 of FIG. 2. FIG. 4 is a cross-sectional view taken along the line 103-103 of FIG. 2. FIG. 5 is a cross-sectional view taken along the line 104-104 of FIG. 2.

As shown in FIG. 1, the multilayer ceramic capacitor 1 has a rectangular or substantially rectangular parallelepiped shape. The multilayer ceramic capacitor 1 includes a multilayer body 2 having a rectangular or substantially rectangular parallelepiped shape and a pair of external electrodes 40 provided at both end portions of the multilayer body 2 so as to be spaced apart from each other.

In FIG. 1, an arrow T indicates a height direction of the multilayer ceramic capacitor 1 and the multilayer body 2. The height direction T is also referred to as a thickness direction and a lamination direction of the multilayer ceramic capacitor 1 and the multilayer body 2. In FIG. 1, an arrow L indicates a length direction orthogonal or substantially orthogonal to the height direction T of the multilayer ceramic capacitor 1 and the multilayer body 2. In FIG. 1, an arrow W indicates a width direction orthogonal or substantially orthogonal to the height direction T and the length direction L of the multilayer ceramic capacitor 1 and the multilayer body 2. The pair of external electrodes 40 are respectively provided at one end portion and the other end portion of the multilayer body 2 in the length direction L.

The cross section shown in FIG. 2 is referred to as an LT cross section. The cross section shown in FIG. 3 is referred to as a WT cross section. The cross section shown in FIG. 4 and the cross section shown in FIG. 5 are referred to as LW cross sections.

### Multilayer Body

Two surfaces of the multilayer body 2 opposed to each other in the height direction T are referred to as a first main surface 3 and a second main surface 4. Two surfaces of the multilayer body opposed to each other in the length direction L orthogonal to the height direction T are referred to as a first end surface 7 and a second end surface 8. Two surfaces of the multilayer body 2 opposed to each other in the width direction W orthogonal to the height direction T and the length direction L are referred to as a first lateral surface 5 and a second lateral surface 6.

As shown in FIG. 1, the multilayer body 2 has a rectangular or substantially rectangular parallelepiped shape. The length of the multilayer body 2 in the length direction L is not necessarily longer than the length in the width direction W. The corner portions and ridge portions of the multilayer body 2 preferably have a rounded shape. The corner portions are portions where three surfaces of the multilayer body intersect. The ridge portions are portions where two surfaces of the multilayer body intersect. A portion or the entirety of the surface of the multilayer body 2 may have a shape with unevenness or the like provided thereon.

The size of the multilayer body 2 is not limited thereto. The preferable dimension of the multilayer body 2 in the length direction L is, for example, about 0.2 mm or more and about 6 mm or less. The preferable dimension of the multilayer body 2 in the height direction T is, for example, about 0.05 mm or more and about 5 mm or less. The preferable dimension of the multilayer body 2 in the width direction W is, for example, about 0.1 mm or more and about 5 mm or less.

### Division in Height Direction

As shown in FIGS. 2 and 3, the multilayer body 2 is divided into an effective layer portion 10 and main surface-side outer layer portions 11 (outer layer portions) in the height direction T. The main surface-side outer layer portions 11 include a first main surface-side outer layer portion 12 and a second main surface-side outer layer portion 13. The first main surface-side outer layer portion 12 and the second main surface-side outer layer portion 13 sandwich the effective layer portion 10 in the height direction T. That is, the multilayer body 2 is divided into the first main surface-side outer layer portion 12, the effective layer portion 10, and the second main surface-side outer layer portion 13.

### Dielectric Layer

The effective layer portion 10 includes a plurality of dielectric layers 20 and a plurality of internal electrode layers 30 alternately laminated in the height direction T. The effective layer portion 10 includes, in the height direction T, from the internal electrode layer 30 located closest to the first main surface 3 to the internal electrode layer 30 located closest to the second main surface 4. In the effective layer portion 10, the plurality of internal electrode layers 30 are opposed to each other with the dielectric layers 20 interposed therebetween. The effective layer portion 10 is a portion that generates capacitance and substantially defines and functions as a capacitor. The dielectric layers 20 included in the effective layer portion 10 are referred to as inner dielectric layers 21. The dielectric layers 20 included in the first main surface-side outer layer portion 12 and the dielectric layers 20 included in the second main surface-side outer layer portion 13 are referred to as outer dielectric layers 22.

The plurality of dielectric layers 20 are made of a dielectric material. Examples of the dielectric material include dielectric ceramics including components such as barium titanate, calcium titanate, strontium titanate, or calcium zirconate. The dielectric material may be obtained by adding sub-components such as, for example, a manganese compound, an iron compound, a copper compound, a cobalt compound, or a nickel compound to these main components. A preferable dielectric material is, for example, a material including barium titanate as a main component.

The preferable thickness of each of the dielectric layers 20 is, for example, about 0.2 μm or more and about 10 μm or less. The preferable number of laminated dielectric layers 20 is, for example, 15 or more and 1200 or less. The number of the dielectric layers 20 is the sum of the number of inner dielectric layers 21 and the number of outer dielectric layers 22.

### Internal Electrode Layer

The plurality of internal electrode layers 30 include a plurality of first internal electrode layers 31 and a plurality of second internal electrode layers 32. The first internal electrode layers 31 and the second internal electrode layers 32 are alternately provided in the height direction T with the dielectric layers 20 interposed therebetween. The first internal electrode layers 31 extend toward the first end surface 7. The second internal electrode layers 32 extend toward the second end surface 8.

As shown in FIG. 4, the first internal electrode layer 31 is divided into a first counter portion 33 and a first extension portion 35. The first counter portion 33 is a portion opposed to the second internal electrode layer 32 with a corresponding one of the dielectric layers 20 interposed therebetween. The first extension portion 35 is a portion extending from the first counter portion 33 toward the first end surface 7. The first extension portion 35 is exposed at the first end surface 7.

As shown in FIG. 5, the second internal electrode layer 32 is divided into a second counter portion 34 and a second extension portion 36. The second counter portion 34 is a portion opposed to the first internal electrode layer 31 with a corresponding one of the dielectric layers 20 interposed therebetween. The second extension portion 36 is a portion extending from the second counter portion 34 toward the second end surface 8. The second extension portion 36 is exposed at the second end surface 8.

In the multilayer ceramic capacitor 1, capacitance is generated by the first counter portions 33 and the second counter portions 34 opposing each other with the dielectric layers 20 interposed therebetween. This enables the multilayer ceramic capacitor 1 to provide capacitor characteristics.

The shapes of the first counter portion 33 and the second counter portion 34 are not limited. The preferred shapes of the first counter portion 33 and the second counter portion 34 are, for example, rectangular or substantially rectangular shapes. Similarly, the shapes of the first extension portion 35 and the second extension portion 36 are not limited. The preferred shapes of the first extension portion 35 and the second extension portion 36 are, for example, rectangular or substantially rectangular shapes. In the above-described rectangular or substantially rectangular shapes, the shapes of the corner portions of the rectangular shapes may be rounded shapes. The shapes of the corner portions of the rectangular or substantially rectangular shapes may be provided obliquely.

The length in the width direction W of the first counter portion 33 and the length in the width direction W of the first extension portion 35 may be the same or substantially the same. Either one of the length in the width direction W of the first counter portion 33 and the length in the width direction W of the first extension portion 35 may be shorter. The length in the width direction W of the second counter portion 34 and the length in the width direction W of the second extension portion 36 may be the same or substantially the same. Either one of the length in the width direction W of the second counter portion 34 and the length in the width direction W of the second extension portion 36 may be shorter.

Examples of materials of the first internal electrode layer 31 and the second internal electrode layer 32 are electrically conductive materials such as metals including nickel, copper, silver, palladium, or gold, or alloys including at least one of these metals. When using an alloy, examples of materials of the first internal electrode layer 31 and the second internal electrode layer 32 include an alloy of silver and palladium.

Examples of preferable thicknesses of each of the first internal electrode layer 31 and the second internal electrode layer 32 are, for example, about 0.2 μm or more and about 2.0 μm or less. The preferred number of layers of the sum of the number of the first internal electrode layers 31 and the number of the second internal electrode layers 32 is, for example, 15 or more and 1000 or less.

### Main Surface-Side Outer Layer Portion

As shown in FIGS. 2 and 3, a portion including an aggregate of a plurality of dielectric layers 20 located between the first main surface 3 and the internal electrode layer 30 closest to the first main surface 3 is referred to as a first main surface-side outer layer portion 12. The first main surface-side outer layer portion 12 is located adjacent to the first main surface 3 of the multilayer body 2. A portion including an aggregate of a plurality of dielectric layers 20 located between the second main surface 4 and the internal electrode layer 30 closest to the second main surface 4 is referred to as a second main surface-side outer layer portion 13. The second main surface-side outer layer portion 13 is located adjacent to the second main surface 4 of the multilayer body 2. The dielectric layers 20 in the first main surface-side outer layer portion 12 and the second main surface-side outer layer portion 13 may be the same as the dielectric layers 20 in the effective layer portion 10. The material of the inner dielectric layers 21 and the material of the outer dielectric layers 22 may be the same.

### Electrode Counter Portion

The portion where the first counter portion 33 of the first internal electrode layer 31 and the second counter portion 34 of the second internal electrode layer 32 are opposed to each other is referred to as the electrode counter portion 14. The electrode counter portion 14 is a portion of the effective layer portion 10. FIGS. 4 and 5 each show the range of the electrode counter portion 14 in the width direction W and the length direction L. The electrode counter portion 14 is also referred to as a capacitor effective portion.

### Division in W Direction

The multilayer body 2 is divided into the first lateral surface-side outer layer portion 15, the electrode counter portion 14, and the second lateral surface-side outer layer portion 16 in the width direction W. The first lateral surface-side outer layer portion 15 is a portion including the dielectric layer 20 located between the electrode counter portion 14 and the first lateral surface 5. The second lateral surface-side outer layer portion 16 is a portion including the dielectric layer 20 located between the electrode counter portion 14 and the second lateral surface 6. FIGS. 3, 4, and 5 each show the range in the width direction W of the first lateral surface-side outer layer portion 15, the electrode counter portion 14, and the second lateral surface-side outer layer portion 16. The first lateral surface-side outer layer portion 15 and the second lateral surface-side outer layer portion 16 are referred to as W gap or side gap.

### Division in L Direction

The multilayer body 2 is divided into the first end surface-side outer layer portion 17, the electrode counter portion 14, and the second end surface-side outer layer portion 18 in the length direction L. The first end surface-side outer layer portion 17 is a portion including the dielectric layer 20 and the first extension portion 35 located between the electrode counter portion 14 and the first end surface 7. The first end surface-side outer layer portion 17 is an aggregate of the portions of the plurality of dielectric layers 20 adjacent to the first end surface 7 and the plurality of first extension portions 35. The second end surface-side outer layer portion 18 is a portion including the dielectric layer 20 and the second extension portion 36 located between the electrode counter portion 14 and the second end surface 8. The second end surface-side outer layer portion 18 is an aggregate of the portions of the plurality of dielectric layers 20 adjacent to the second end surface 8 and the plurality of second extension portions 36. FIGS. 2, 4, and 5 each show the range in the length direction L of the first end surface-side outer layer portion 17, the electrode counter portion 14, and the second end surface-side outer layer portion 18. The first end surface-side outer layer portion 17 and the second end surface-side outer layer portion 18 are referred to as L gap or end gap.

### External Electrode

The external electrode 40 includes a first external electrode 41 and a second external electrode 42. The first external electrode 41 is an external electrode provided adjacent to the first end surface 7 of the multilayer body 2. The second external electrode 42 is an external electrode provided adjacent to the second end surface 8 of the multilayer body 2.

The basic configuration of the first external electrode 41 and the second external electrode 42 is the same or substantially the same. The first external electrode 41 and the second external electrode 42 have a plane-symmetric or substantially plane-symmetric shape with respect to the WT cross section at the middle in the length direction L of the multilayer ceramic capacitor 1.

The first external electrode 41 is provided on the first end surface 7. The first external electrode 41 is in contact with each of the first extension portions 35 of the plurality of first internal electrode layers 31 exposed at the first end surface 7. The first external electrode 41 is electrically connected to the plurality of first internal electrode layers 31. The first external electrode 41 may also be provided on a portion of the first main surface 3 and a portion of the second main surface 4, and on a portion of the first lateral surface 5 and a portion of the second lateral surface 6. In the present example embodiment, the first external electrode 41 extends from the first end surface 7 to a portion of the first main surface 3 and a portion of the second main surface 4, and to a portion of the first lateral surface 5 and a portion of the second lateral surface 6.

The second external electrode 42 is provided on the second end surface 8. The second external electrode 42 is in contact with each of the second extension portions 36 of the plurality of second internal electrode layers 32 exposed at the second end surface 8. The second external electrode 42 is electrically connected to the plurality of second internal electrode layers 32. The second external electrode 42 may also be provided on a portion of the first main surface 3 and a portion of the second main surface 4, and on a portion of the first lateral surface 5 and a portion of the second lateral surface 6. In the present example embodiment, the second external electrode 42 extends from the second end surface 8 to a portion of the first main surface 3 and a portion of the second main surface 4, and to a portion of the first lateral surface 5 and a portion of the second lateral surface 6.

In the multilayer body 2, capacitance is generated by the first counter portions 33 of the first internal electrode layers 31 and the second counter portions 34 of the second internal electrode layers 32 being opposed to each other with a corresponding one of the dielectric layers 20 interposed therebetween. Therefore, capacitor characteristics are provided between the first external electrode 41 connected to the first internal electrode layers 31 and the second external electrode 42 connected to the second internal electrode layers 32.

### Base Electrode Layer

As shown in FIGS. 2, 4, and 5, the first external electrode 41 includes a first base electrode layer 51 and a first plated layer 71. The first plated layer 71 is provided on the first base electrode layer 51. The second external electrode 42 includes a second base electrode layer 52 and a second plated layer 72. The second plated layer 72 is provided on the second base electrode layer 52.

The first base electrode layer 51 is provided on the first end surface 7. The first base electrode layer 51 is in contact with each of the first extension portions 35 of the plurality of first internal electrode layers 31 exposed at the first end surface 7. The first base electrode layer 51 extends from the first end surface 7 to a portion of the first main surface 3 and a portion of the second main surface 4, and to a portion of the first lateral surface 5 and a portion of the second lateral surface 6.

The second base electrode layer 52 is provided on the second end surface 8. The second base electrode layer 52 is in contact with each of the second extension portions 36 of the plurality of second internal electrode layers 32 exposed at the second end surface 8. The second base electrode layer 52 extends from the second end surface 8 to a portion of the first main surface 3 and a portion of the second main surface 4, and to a portion of the first lateral surface 5 and a portion of the second lateral surface 6.

The first base electrode layer 51 and the second base electrode layer 52 are fired layers. The fired layers preferably include a metal component. The fired layers preferably include at least one of a glass component and a ceramic component in addition to the metal component. The metal component includes, for example, at least one of copper, nickel, silver, palladium, an alloy of silver and palladium, gold, or the like. The glass component includes, for example, at least one of boron, silicon, barium, magnesium, aluminum, lithium, or the like. The ceramic component may be the same type of ceramic material as the dielectric layer 20. The ceramic component may be a different type of ceramic material from the dielectric layer 20. The ceramic component includes, for example, at least one of barium titanate, calcium titanate, a mixed crystal material in which a portion of barium in barium titanate is substituted with calcium, strontium titanate, calcium zirconate, or the like.

An example of the fired layer is a layer formed by applying an electrically conductive paste including glass and metal to a multilayer body, and firing it. The fired layer is formed by simultaneously firing a multilayer chip, which is a material of a multilayer body including a plurality of internal electrode layers and a plurality of dielectric layers before firing, and an electrically conductive paste applied to the multilayer chip. Alternatively, the fired layer is formed by firing the multilayer chip to obtain a multilayer body, then applying an electrically conductive paste to the multilayer body, and firing it. When firing the electrically conductive paste after obtaining the multilayer body, it is preferable that the fired layer is formed by firing an electrically conductive paste to which a ceramic material is added instead of a glass component. When using an electrically conductive paste to which a ceramic material is added, it is preferable that the ceramic material to be added is the same type of ceramic material as the dielectric layer. The fired layer may include a plurality of layers.

An example of a preferred thickness in the length direction L of the first base electrode layer 51 on the first end surface 7 is about 10 μm or more and about 200 μm or less at the middle portion in the height direction T and the width direction W of the first base electrode layer 51.

An example of a preferred thickness in the length direction L of the second base electrode layer 52 on the second end surface 8 is about 10 μm or more and about 200 μm or less at the middle portion in the height direction T and the width direction W of the second base electrode layer 52.

In a case of providing the first base electrode layer 51 on a portion of at least one of the first main surface 3 or the second main surface 4, an example of a preferred thickness in the height direction T of the first base electrode layer 51 provided in this portion is about 3 μm or more and about 40 μm or less at the middle portion in the length direction L and the width direction W of the first base electrode layer 51 provided in this portion.

In a case of providing the first base electrode layer 51 on a portion of at least one of the first lateral surface 5 or the second lateral surface 6, an example of a preferred thickness in the width direction W of the first base electrode layer 51 provided in this portion is about 3 μm or more and about 40 μm or less at the middle portion in the length direction L and the height direction T of the first base electrode layer 51 provided in this portion.

In a case of providing the second base electrode layer 52 on a portion of at least one of the first main surface 3 or the second main surface 4, an example of a preferred thickness in the height direction T of the second base electrode layer 52 provided in this portion is about 3 μm or more and about 40 μm or less at the middle portion in the length direction L and the width direction W of the second base electrode layer 52 provided in this portion.

In a case of providing the second base electrode layer 52 on a portion of at least one of the first lateral surface 5 or the second lateral surface 6, an example of a preferred thickness in the width direction W of the second base electrode layer 52 provided in this portion is about 3 μm or more and about 40 μm or less at the middle portion in the length direction L and the height direction T of the second base electrode layer 52 provided in this portion.

The first plated layer 71 covers the first base electrode layer 51. The second plated layer 72 covers the second base electrode layer 52.

The first plated layer 71 and the second plated layer 72 may include at least one of, for example, copper, nickel, tin, silver, palladium, an alloy of silver and palladium, or gold. The first plated layer 71 and the second plated layer 72 may each include a plurality of layers. A preferable configuration of the first plated layer 71 and the second plated layer 72 is, for example, a two-layer configuration in which a tin plated layer is provided on a nickel plated layer.

The first plated layer 71 covers the first base electrode layer 51. In an example embodiment, for example, the first plated layer 71 includes a first nickel plated layer 73 and a first tin plated layer 75. The first tin plated layer 75 is located on the first nickel plated layer 73.

The second plated layer 72 covers the second base electrode layer 52. In an example embodiment, for example, the second plated layer 72 includes a second nickel plated layer 74 and a second tin plated layer 76. The second tin plated layer 76 is located on the second nickel plated layer 74.

The nickel plated layer reduces or prevents the erosion of the first base electrode layer 51 and the second base electrode layer 52 by solder when mounting the multilayer ceramic capacitor 1. The tin plated layer improves the wettability of solder when mounting the multilayer ceramic capacitor 1. The tin plated layer facilitates mounting of the multilayer ceramic capacitor 1. A preferred thickness of each of the first nickel plated layer 73, the first tin plated layer 75, the second nickel plated layer 74, and the second tin plated layer 76 is, for example, about 2 μm or more and about 10 μm or less.

The external electrode 40 may include, for example, an electrically conductive resin layer including electrically conductive particles and a thermosetting resin. When the external electrode 40 includes an electrically conductive resin layer, the electrically conductive resin layer may cover a fired layer. When the electrically conductive resin layer covers the fired layer, the electrically conductive resin layer is provided between the fired layer and a plated layer. The fired layer corresponds to the first base electrode layer 51 and the second base electrode layer 52. The plated layer corresponds to the first plated layer 71 and the second plated layer 72. The electrically conductive resin layer may completely cover the fired layer. The electrically conductive resin layer may cover a portion of the fired layer.

The electrically conductive resin layer including, for example, a thermosetting resin is more flexible than an electrically conductive layer made of a plating film or a fired product of an electrically conductive paste. Therefore, when a physical impact or shock caused by thermal cycling is applied to the multilayer ceramic capacitor, the electrically conductive resin layer defines and functions as a buffer layer. Therefore, the electrically conductive resin layer reduces or prevents the occurrence of cracks in the multilayer ceramic capacitor.

Examples of metals of the electrically conductive particles include silver, copper, nickel, tin, bismuth, or an alloy including at least two of these metals. The electrically conductive particles preferably include silver, for example. An example of the electrically conductive particles is silver metal powder. Silver has the lowest resistivity among metals. Silver is suitable for electrode materials. Silver is a precious metal. Silver is difficult to oxidize. Silver has high weather resistance. For these reasons, for example, silver metal powder is suitable as electrically conductive particles.

The electrically conductive particles may be, for example, metal powder having a surface coated with silver. When using electrically conductive particles in which the surface of metal powder is coated with silver, the metal powder is, for example, preferably powder of copper, nickel, tin, bismuth, or an alloy thereof. In order to make the base metal inexpensive while maintaining the characteristics of silver, it is preferable to use silver-coated metal powder.

The electrically conductive particles may be, for example, copper or nickel subjected to oxidation prevention treatment. The electrically conductive particles may be, for example, metal powder having a surface coated with tin, nickel, or copper. When using metal powder having a surface coated with tin, nickel, or copper, the metal powder is, for example, preferably silver, copper, nickel, tin or bismuth, or an alloy powder including at least two of these metals.

The shape of the electrically conductive particles is not limited. Examples of the shape of the electrically conductive particles include spherical shape and flat shape. It is preferable to use a mixture of spherical metal powder and flat metal powder.

The electrically conductive particles included in the electrically conductive resin layer mainly play a role in ensuring the electrical conductivity of the electrically conductive resin layer. By contact between the plurality of electrically conductive particles, an electrically conductive path is provided inside the electrically conductive resin layer.

Examples of the resin of the electrically conductive resin layer may include, for example, at least one of various known thermosetting resins such as epoxy resin, phenol resin, urethane resin, silicone resin, or polyimide resin. Among them, for example, one of the suitable resins is epoxy resin. Epoxy resin is excellent in heat resistance, moisture resistance, and adhesion. The resin of the electrically conductive resin layer preferably includes, for example, a curing agent together with the thermosetting resin. When epoxy resin is used as the base resin, the curing agent for the epoxy resin may be various known compounds such as, for example, phenolic type, amine type, acid anhydride type, imidazole-based, active ester type, or amidoimide type compounds.

The electrically conductive resin layer may include a plurality of layers. The preferred thickness of the thickest portion of the electrically conductive resin layer is, for example, about 10 μm or more and about 150 μm or less.

The above is the basic configuration of the multilayer ceramic capacitor 1. The preferred length in the length direction L of the multilayer ceramic capacitor 1 including the multilayer body 2 and the external electrode 40 is, for example, about 0.2 mm or more and about 6 mm or less. The preferred length in the height direction T of the multilayer ceramic capacitor 1 is, for example, about 0.05 mm or more and about 5 mm or less. The preferred length in the width direction W of the multilayer ceramic capacitor 1 is, for example, about 0.1 mm or more and about 5 mm or less.

### Segregation of Magnesium or Manganese

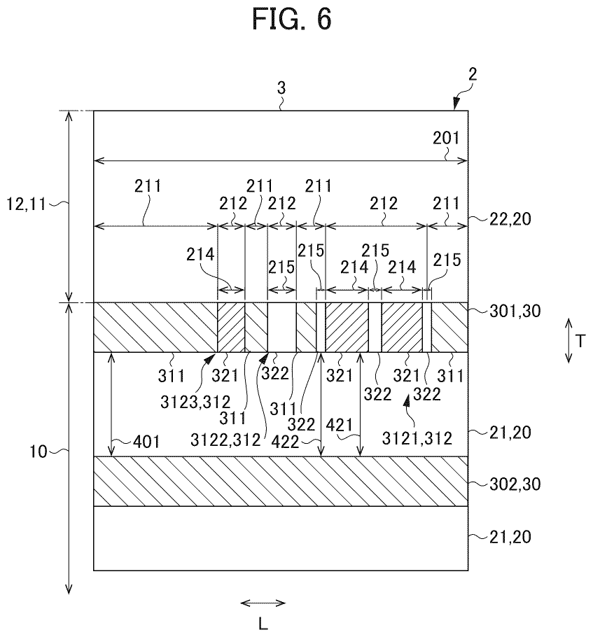

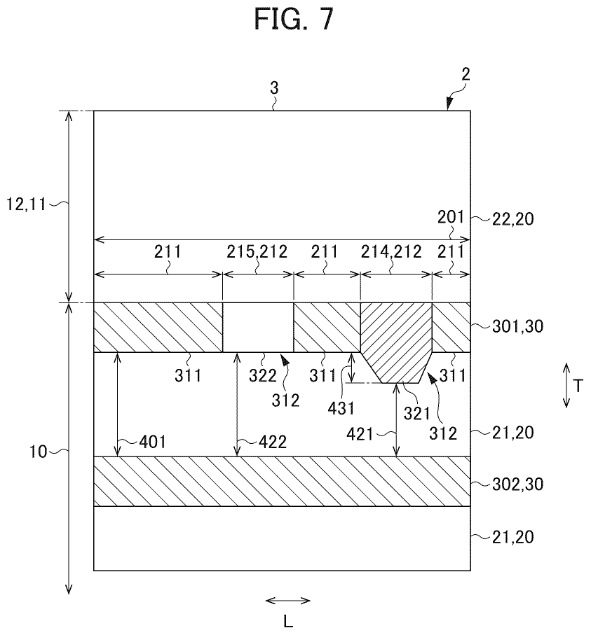

In the multilayer ceramic capacitor 1 of the present example embodiment, a region where magnesium or manganese is segregated is provided in the internal electrode layer 30. This will be described with reference to FIG. 6 and FIG. 7. FIG. 6 is an enlarged view of a frame 110 in FIG. 2. FIG. 6 shows a portion of the LT cross section of the ceramic capacitor 1. FIG. 7 is a diagram showing a portion similar to FIG. 6 in a conventional multilayer ceramic capacitor.

### Outermost Internal Electrode Layer and Inner-Side Internal Electrode Layer

Among the internal electrode layers 30, the internal electrode layer 30 closest to the main surface-side outer layer portion 11 is defined as the outermost internal electrode layer 301. Among the internal electrode layers 30, the internal electrode layer 30 provided on the inner side of the multilayer body 2 in the height direction T from the outermost internal electrode layer 301 is defined as the inner-side internal electrode layer 302. The outermost internal electrode layer 301 shown in FIG. 6 is the internal electrode layer 30 in contact with the first main surface-side outer layer portion 12. In this case, the internal electrode layer 30 provided on the inner side refers to the internal electrode layer 30 provided on the side approaching the second main surface-side outer layer portion 13.

### Internal Electrode Existing Region and Internal Electrode Dividing Region

The outermost internal electrode layer 301 includes an internal electrode existing region 311 and an internal electrode dividing region 312. Similarly, the inner-side internal electrode layer 302 includes an internal electrode existing region 311 and an internal electrode dividing region 312.

The internal electrode existing region 311 and the internal electrode dividing region 312 will be described. In the following description, the internal electrode existing region 311 and the internal electrode dividing region 312 will be described using the outermost internal electrode layer 301 as an example. In addition, what is described below also applies to the inner-side internal electrode layer 302. In FIG. 6 and FIG. 7, descriptions of the internal electrode existing region 311 and the internal electrode dividing region 312 in the inner-side internal electrode layer 302 are omitted.

The internal electrode existing region 311 refers to a region where the internal electrode layer 30 continuously exists in the length direction L in the LT cross section. The internal electrode dividing region 312 refers to a region where the internal electrode layer 30 is divided in the length direction L in the LT cross section. The material of the internal electrode layer 30 does not exist in the internal electrode dividing region 312. In the internal electrode dividing region 312, the material of the internal electrode layer 30 is missing.

### Segregated Region and Non-Segregated Region

The internal electrode dividing region 312 includes a segregated region 321 and a non-segregated region 322. The segregated region 321 refers to a region where magnesium or manganese is segregated. The non-segregated region 322 refers to a region where neither magnesium nor manganese is segregated. Magnesium and manganese are usually segregated as oxides.

There are various distribution configurations of the segregated regions 321 and the non-segregated regions 322 in the internal electrode dividing region 312. One internal electrode dividing region 312 may include one or a plurality of segregated regions 321 and one or a plurality of non-segregated regions 322. One internal electrode dividing region 312 may include only one segregated region 321 or only one non-segregated region 322.

The first internal electrode dividing region 3121 shown in FIG. 6 is an example that includes a plurality of segregated regions 321 and a plurality of non-segregated regions 322. The first internal electrode dividing region 3121 includes two segregated regions 321 and three non-segregated regions 322.

The second internal electrode dividing region 3122 shown in FIG. 6 is an example that includes only the non-segregated region 322, and does not include the segregated region 321. The third internal electrode dividing region 3123 is an example that includes only the segregated region 321 and does not include the non-segregated region 322.

### Ratio of Distance Between Internal Electrode Existing Region and Segregated Region

The distance of the segregated region 321 will be described. The distance in the length direction L of the internal electrode existing region 311 is defined as distance A. The distance in the length direction L of the segregated region 321 is defined as distance B. In the multilayer ceramic capacitor 1 of the present example embodiment, for example, distance B/distance A is about 50% or more and about 75% or less.

In FIG. 6, distance 201 indicates the distance in the length direction L of the internal electrode layer 30. Distance 211 indicates the distance in the length direction L of the internal electrode existing region 311. Distance 212 indicates the distance in the length direction L of the internal electrode dividing region 312. Distance 214 indicates the distance in the length direction L of the segregated region 321. Distance 215 indicates the distance in the length direction L of the non-segregated region 322.

The distance B in the distance B/distance A is the sum of the distances 214 of the segregated regions 321 included in the internal electrode layer 30 of a predetermined length. Similarly, the distance A in distance B/distance A is the sum of the distances 211 of the internal electrode existing regions 311 included in the internal electrode layer 30 of a predetermined length. That is, the distance B/distance A indicates the ratio of the sum of distances 214 to the sum of distances 211 in the internal electrode layer 30 of a predetermined distance. Similarly, for each distance described below, when there are multiple objects, each distance is the sum of the distances of the multiple objects.

Here, the predetermined length can be, for example, about 20 μm.

In the multilayer ceramic capacitor 1 of the present example embodiment, for example, distance B/distance A is about 50% or more and about 75% or less. With this configuration, it is possible for the multilayer ceramic capacitor 1 of the present example embodiment to reduce or prevent the thinning of the dielectric layer 20 due to the segregation of oxides such as magnesium or manganese, for example. As a result, it is possible for the multilayer ceramic capacitor 1 of the present example embodiment to improve high-temperature load reliability.

### Protrusion of Segregated Region

The thinning of the dielectric layer will be described with reference to FIG. 7 in addition to FIG. 6. FIG. 7 is a diagram showing a similar portion to that in FIG. 6 for a conventional multilayer ceramic capacitor.

When distance B/distance A becomes smaller than about 50% or more, high-temperature load reliability tends to decrease. A decrease in distance B/distance A indicates that the distance in the length direction L of the segregated region 321 becomes relatively shorter in the internal electrode layer 30.

It is assumed that the same amount of magnesium oxide or manganese oxide is segregated in the multilayer ceramic capacitor 1 of the present example embodiment shown in FIG. 6 and the conventional multilayer ceramic capacitor shown in FIG. 7. Magnesium oxide or manganese oxide is likely to be segregated in the internal electrode dividing region 312 of the internal electrode layer 30.

In both of the multilayer ceramic capacitor 1 of the present example embodiment shown in FIG. 6 and the conventional multilayer ceramic capacitor shown in FIG. 7, the segregated region 321 is located within the internal electrode dividing region 312 in the length direction L.

However, in the multilayer ceramic capacitor 1 of the present example embodiment shown in FIG. 6, the segregated region 321 does not protrude from the internal electrode layer 30 in the height direction T. That is, the segregated region 321 is included within the internal electrode dividing region 312. This is because the distance B, that is, the distance of the segregated region 321 in the length direction L, is sufficiently long in the multilayer ceramic capacitor 1 of the present example embodiment.

On the other hand, in the conventional multilayer ceramic capacitor shown in FIG. 7, the segregated region 321 protrudes from the internal electrode layer 30 in the height direction T. That is, the segregated region 321 is not included within the internal electrode dividing region 312. This is because the distance B, that is, the distance of the segregated region 321 in the length direction L, is short in the conventional multilayer ceramic capacitor.

### Distance of Internal Electrode Dividing Region

One factor that causes the segregated region 321 to protrude from the internal electrode layer 30 in the height direction T in the conventional multilayer ceramic capacitor is considered to be that the length 212 of the internal electrode dividing region 312 in the length direction L is not sufficiently long relative to the amount of magnesium oxide or manganese oxide. In the conventional multilayer ceramic capacitor, no non-segregated region 322 remains in the internal electrode dividing region 312 where the segregated region 321 is provided.

In contrast, in the multilayer ceramic capacitor 1 of the present example embodiment shown in FIG. 6, the non-segregated region 322 remains in the internal electrode dividing region 3121 where the segregated region 321 is formed. This indicates that the length 212 of the internal electrode dividing region 312 in the length direction L is sufficiently long relative to the amount of magnesium oxide or manganese oxide.

That is, as described above, magnesium oxide or manganese oxide is likely to be segregated in the internal electrode dividing region 312 of the internal electrode layer 30. Therefore, in order to confine the segregated region 321 within the internal electrode dividing region 312 and prevent the segregated region 321 from protruding from the internal electrode layer 30 in the height direction T, it is preferable that the length 212 of the internal electrode dividing region 312 in the length direction L is sufficiently long to accommodate the magnesium oxide or manganese oxide.

### Thinning of Dielectric Layer

The thickness of the inner dielectric layer 21 will be described with reference to FIGS. 6 and 7. Arrows 401, 421, and 422 in FIG. 6 indicate the thickness of the inner dielectric layer 21 between the outermost internal electrode layer 301 and the inner-side internal electrode layer 302 in the multilayer ceramic capacitor 1 of the present example embodiment.

The thickness 401 indicates the thickness of the inner dielectric layer 21 in the internal electrode existing region 311 of the outermost internal electrode layer 301. The thickness 421 indicates the thickness of the inner dielectric layer 21 in the segregated region 321 of the outermost internal electrode layer 301. The thickness 422 indicates the thickness of the inner dielectric layer 21 in the non-segregated region 322 of the outermost internal electrode layer 301.

In the conventional multilayer ceramic capacitor shown in FIG. 7, the thickness 421 is thinner than the thickness 401 and the thickness 422. This is because the segregated region 321 protrudes from the internal electrode layer 30 in the height direction T. Arrow 431 in FIG. 7 indicates the distance by which the segregated region 321 protrudes from the internal electrode layer 30 in the height direction T. The thickness 421 of the inner dielectric layer 21 in the segregated region 321 is reduced by the distance 431 by which the segregated region 321 protrudes from the internal electrode layer 30.

In contrast, in the multilayer ceramic capacitor 1 of the present example embodiment, the thickness 421 is equal or substantially equal to the thickness 401 and the thickness 422. In the multilayer ceramic capacitor 1 of the present example embodiment, the segregated region 321 does not protrude from the internal electrode layer 30 in the height direction T. Therefore, the thickness of the inner dielectric layer 21 in the segregated region 321 is the same or substantially the same as the thickness of the inner dielectric layer 21 in the internal electrode existing region 311.

Thus, it is possible for the multilayer ceramic capacitor 1 of the present example embodiment to reduce or prevent the thinning of the dielectric layer 20 due to segregation of oxides such as magnesium or manganese. As a result, it is possible for the multilayer ceramic capacitor 1 of the present example embodiment to improve high-temperature load reliability.

### When Distance B/Distance A is Greater than About 75%

Next, a case where distance B/distance A is greater than about 75% will be described. When distance B/distance A becomes greater than about 75%, metals such as nickel of the internal electrode layer 30 tend to form beads more easily. The beaded metal may protrude from the surface of the internal electrode layer 30 in the height direction T. Also, the beaded metal may be provided inside the dielectric layer 20. As a result, the dielectric layer 20 becomes substantially thinner, and the high-temperature load reliability of the multilayer ceramic capacitor decreases.

### Length of Segregated Region and Length of Non-Segregated Region

It is preferable that the internal electrode dividing region 312 of the multilayer ceramic capacitor 1 of the present example embodiment includes a non-segregated region 322, and the distance in the length direction L of the segregated region 321 in the internal electrode dividing region 312 is longer than the distance in the length direction L of the non-segregated region 322 in the internal electrode dividing region 312. Here, the non-segregated region 322 refers to a region where magnesium or manganese is not segregated.

Also, when a plurality of segregated regions 321 are included in the internal electrode dividing region 312, the distance of the segregated region 321 refers to the sum of the distances of the plurality of segregated regions 321. Similarly, when a plurality of non-segregated regions 322 are included in the internal electrode dividing region 312, the distance of the non-segregated region 322 refers to the sum of the distances of the plurality of non-segregated regions 322.

The internal electrode dividing region 3121 in FIG. 6 will be described as an example. The internal electrode dividing region 3121 includes two segregated regions 321 and three non-segregated regions 322 in the length direction L. The distance in the length direction L of the segregated region 321 in the internal electrode dividing region 3121 is the sum of the distances 214 in the length direction L of the two segregated regions 321 included in the internal electrode dividing region 3121. Similarly, the distance in the length direction L of the non-segregated region 322 in the internal electrode dividing region 3121 is the sum of the distances 215 in the length direction L of the three non-segregated regions 322 included in the internal electrode dividing region 3121.

As shown in FIG. 6, the sum of the distances 214 in the length direction L of the two segregated regions 321 is longer than the sum of the distances 215 in the length direction L of the three non-segregated regions 322. Thus, by making the distance in the length direction L of the segregated region 321 in the internal electrode dividing region 312 longer than the distance in the length direction L of the non-segregated region 322, it is possible to further reduce or prevent the thinning of the dielectric layer 20 due to protrusion of the segregated region 321 in the height direction T. As a result, it is possible to further improve the high-temperature load reliability of the multilayer ceramic capacitor 1.

### Distance B/Distance A in Outermost Internal Electrode Layer and Distance B/Distance A in Inner-Side Internal Electrode Layer

In the multilayer ceramic capacitor 1 of the present example embodiment, it is preferable that the ratio (C) of the distance B/distance A of the inner-side internal electrode layer 302 to the distance B/distance A of the outermost internal electrode layer 301 is, for example, about 0.1 or more and about 0.6 or less.

By having the ratio (C) be about 0.1 or more and about 0.6 or less, it is possible to increase the distance in the length direction L of the non-segregated region 322 included in the outermost internal electrode layer 301, while maintaining the distance 211 in the length direction L of the internal electrode existing region 311 included in the inner-side internal electrode layer 302, that is, while reducing the distance 212 in the length direction L of the internal electrode dividing region 312 included in the inner-side internal electrode layer 302. With such a configuration, it is possible to improve the reliability of the multilayer ceramic capacitor 1, while maintaining the capacitance of the multilayer ceramic capacitor 1.

On the other hand, when the ratio (C) is less than about 0.1, the distance in the length direction L of the segregated region 321 included in the inner-side internal electrode layer 302 becomes short, making it difficult to maintain the capacitance of the multilayer ceramic capacitor 1.

### Continuity of Inner-Side Internal Electrode Layers

In the multilayer ceramic capacitor 1 of the present example embodiment, it is preferable that the ratio D of the distance 214 in the length direction L of the segregated region 321 included in the inner-side internal electrode layer 302 to the distance 211 in the length direction L of the internal electrode existing region 311 included in the inner-side internal electrode layer 302 is, for example, about 75% or more and about 100% or less. When the distances of the internal electrode existing region 311 and the segregated region 321 in the inner-side internal electrode layer 302 satisfy the above-described conditions, it is possible to obtain the inner-side internal electrode layer 302 with high continuity. As a result, it is possible to ensure high capacitance in the multilayer ceramic capacitor 1.

The ratio (C) of the distance B/distance A of the inner-side internal electrode layer 302 to the distance B/distance A of the outermost internal electrode layer 301 is, for example, about 0.1 or more and about 0.6 or less. The ratio D of the distance 214 in the length direction L of the segregated region 321 included in the inner-side internal electrode layer 302 to the distance 211 in the length direction L of the internal electrode existing region 311 included in the inner-side internal electrode layer 302 is, for example, about 25% or less.

On the other hand, when the above-described distance ratio D is less than about 75%, metals such as nickel of the internal electrode layer 30 are likely to form beads in the inner-side internal electrode layer 302. The beaded metal may protrude from the surface of the internal electrode layer 30 in the height direction T. In this case, the beaded metal makes the dielectric layer 20 thinner. As a result, the high-temperature load reliability of the multilayer ceramic capacitor deteriorates.

In addition, when the above-described distance ratio D is less than about 75%, the continuity of the inner-side internal electrode layer 302 decreases. As a result, it becomes difficult to ensure high capacitance in the multilayer ceramic capacitor 1.

### Continuity of Inner-Side Internal Electrode Layers

In the multilayer ceramic capacitor 1 of the present example embodiment, it is preferable that the ratio E of the distance 214 in the length direction L of the segregated region 321/the distance 212 in the length direction L of the internal electrode dividing region 312 in the outermost internal electrode layer 301 is, for example, about 90% or more and about 100% or less.

When the segregated region 321 and the internal electrode dividing region 312 of the outermost internal electrode layer 301 satisfy the above-described ratio, it is possible to reduce or prevent thinning of the dielectric layer 20 due to segregation of magnesium oxide or manganese oxide. As a result, it is possible to further improve the high-temperature load reliability of the multilayer ceramic capacitor 1.

When the above-described ratio E is less than about 90%, the thickness of the dielectric layer 20 tends to become thin in any void of the internal electrode layer 30 where segregation of magnesium oxide or manganese oxide is concentrated, that is, in the non-segregated region 322 of the internal electrode dividing region 312. When the thickness of the dielectric layer 20 becomes thin, an electric field concentrates on the thin portion of the dielectric layer 20. As a result, the multilayer ceramic capacitor 1, particularly the dielectric layer 20, deteriorates, the insulation resistance decreases, and consequently the multilayer ceramic capacitor 1 is likely to fail.

### Measurement Method

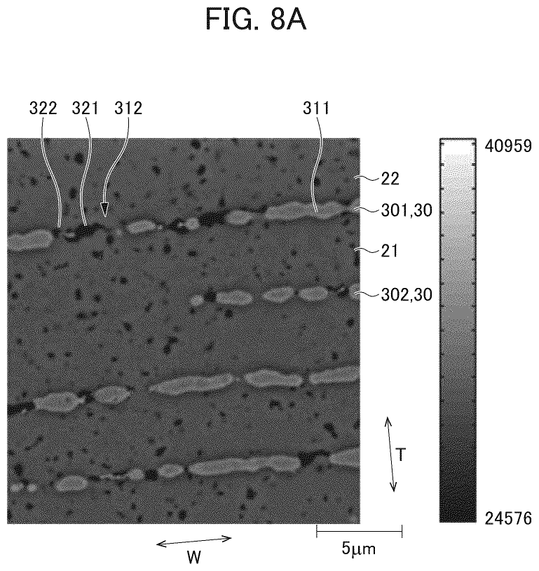

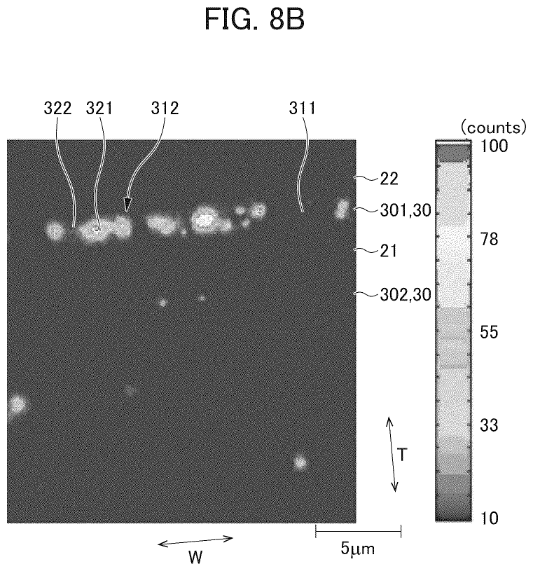

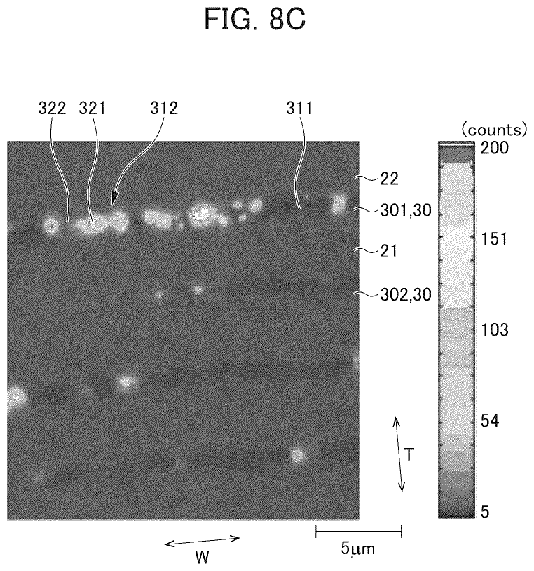

With reference to FIGS. 8A to 8C, an example of a measurement method for the distance in the length direction L of the segregated region 321 and the like will be described. FIGS. 8A to 8C are diagrams showing the results of observing the WT cross section of the multilayer ceramic capacitor 1 of the present example embodiment. FIGS. 8A to 8C show the results of observing the same portion of the multilayer ceramic capacitor 1. FIG. 8A shows an image of a scanning electron microscope (SEM). FIGS. 8B and 8C show analysis images by a wavelength dispersion X-ray analyzer (WDX: Wave Length-dispersive X-ray Spectroscopy). Specifically, FIG. 8B is a mapping image of magnesium. FIG. 8C is a mapping image of manganese.

The observation position of the WT cross section is the middle position in the length direction L and the middle position in the width direction W of the multilayer ceramic capacitor 1. The position in the height direction T is the effective layer portion 10 near the boundary with the first main surface-side outer layer portion 12. That is, it is a portion near the internal electrode layer 30 that includes the internal electrode layer 30 closest to the first main surface 3 in the height direction T. The shape and size of the WT cross section to be observed can be, for example, a square with a side length of about 20 μm.

### Distance Measurement

The distances of each portion such as the internal electrode existing region 311 described above can be measured from the scanning electron microscope image shown in FIG. 8A. During measurement, distance measurement becomes easier by aligning the scale direction of the scanning electron microscope with the continuous direction of the internal electrode layer 30.

### Measurement of Segregation of Magnesium and Manganese

The segregation of magnesium and manganese is measured using a wavelength dispersion X-ray analyzer. Specifically, for magnesium, a region of about 30 counts per second (cps: the number of photoelectrons entering the detector per second) or more is defined as a segregated region, and for manganese, a region of about 50 counts per second or more is defined as a segregated region. Conversely, a region where the count number is less than these values is defined as a non-segregated region.

As an example of the measurement procedure, first, the distances of the internal electrode existing region 311 and the internal electrode dividing region 312 are determined from an image obtained by a scanning electron microscope. Subsequently, the internal electrode dividing region 312 is observed using a wavelength dispersion X-ray analyzer. Specifically, the internal electrode dividing region 312 is observed using a wavelength dispersion X-ray analyzer, and from the obtained mapping image, the distance of the magnesium or manganese segregated region 321 or the non-segregated region 322 included in the internal electrode dividing region 312 is measured based on the above-mentioned criteria. In this way, it is possible to determine the proportion occupied by the segregated region 321 and the non-segregated region 322 in the internal electrode dividing region 312.

### Examples and Comparative Examples

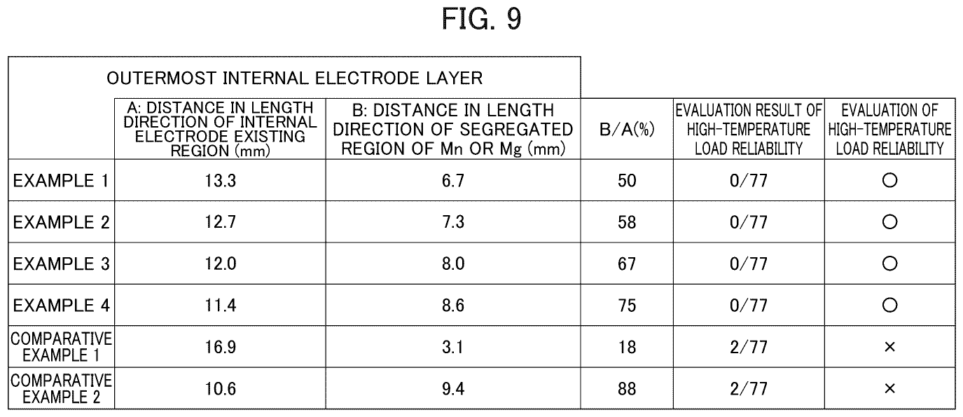

With reference to FIG. 9, Examples and Comparative Examples of the multilayer ceramic capacitor 1 of the present example embodiment will be described. The samples used for evaluation of the Examples and Comparative Examples are as follows.

### Samples

Dimensions of multilayer ceramic capacitor: Length direction L about 3.15 mm, Height direction T about 1.65 mm, Width direction W about 1.65 mm
Ceramic material of dielectric layer: Barium titanate
Capacitance of multilayer ceramic capacitor: about 0.01 μF
Metal material of internal electrode layer: Nickel

### Evaluation Method for High-Temperature Load Reliability

Applied voltage: about 756 V (×1.2 W.V.)
Temperature and time: about 125 degrees, about 2000 hours
Number of evaluated samples: 77
Evaluation criteria: Samples with significant defects in appearance were determined as reliability failure
○ (Good) indicates 0 reliability failures, × (Poor) indicates 1 or more reliability failures

### Evaluation Results

As shown in FIG. 9, when the distance B/distance A in the outermost internal electrode layer 301 was about 50% or more and about 75% or less, the evaluation of high-temperature load reliability was ○ (good). In contrast, when the distance B/distance A was less than about 50% and when the distance B/distance A exceeded about 75%, the evaluation of high-temperature load reliability was × (poor).

The distance B/distance A was measured on samples different from the 77 samples, taken from the same manufacturing lot as the 77 samples used for to evaluate high-temperature load reliability.

### Manufacturing Method of Multilayer Ceramic Capacitor

An example of a manufacturing method of a multilayer ceramic capacitor according to an example embodiment of the present invention will be described. The manufacturing method of the multilayer ceramic capacitor is not limited to the following method.

A dielectric sheet for manufacturing the dielectric layer 20 and an electrically conductive paste for manufacturing the internal electrode layer 30 are prepared. Both of the dielectric sheet for manufacturing the dielectric layer 20 and the electrically conductive paste for manufacturing the internal electrode layer 30 include a binder and a solvent. The binder and solvent may be known. An example of a paste made of an electrically conductive material is a paste in which an organic binder and an organic solvent are added to metal powder.

On the dielectric sheet, the electrically conductive paste for manufacturing the internal electrode layer 30 is printed using a printing plate designed to have the shape of the internal electrode layer 30. Examples of printing methods are screen printing and gravure printing. With this, a dielectric sheet on which a pattern of the first internal electrode layer 31 is formed and a dielectric sheet on which a pattern of the second internal electrode layer 32 is formed are prepared.

By laminating a predetermined number of dielectric sheets on which patterns of the internal electrode layers 30 are not printed, a portion defining and functioning as the first main surface-side outer layer portion 12 adjacent to the first main surface 3 is formed. On top of that, the dielectric sheets on which the pattern of the first internal electrode layer 31 is printed and the dielectric sheets on which the pattern of the second internal electrode layer 32 is printed are sequentially and alternately laminated to form a portion functioning as the effective layer portion 10. A predetermined number of dielectric sheets on which patterns of the internal electrode layers 30 are not printed are laminated on the portion defining and functioning as the effective layer portion 10 to form a portion defining and functioning as the second main surface-side outer layer portion 13 adjacent to the second main surface 4. A multilayer sheet is thus obtained.

Here, the number of dielectric sheets corresponding to the first main surface-side outer layer portion 12 and the second main surface-side outer layer portion 13 is adjusted so that the thickness of the main surface-side outer layer portion 11 is increased. This makes it possible to diffuse magnesium and manganese included in the dielectric layers of the main surface-side outer layer portion 11 to the outermost internal electrode layer 301. The thickness of each of the first main surface-side outer layer portion 12 and the second main surface-side outer layer portion 13 after firing can be, for example, about 50 μm or more and about 400 μm or less.

Also, in order to increase the thickness of the internal electrode layers 30, for example, when printing the electrically conductive paste for the internal electrode layers 30, the thickness of the paste is increased. This makes it possible to increase the continuity of the internal electrode layers 30, particularly the inner-side internal electrode layers 302. That is, in the internal electrode layers 30, it is possible to reduce the ratio of the internal electrode dividing regions 312 to the internal electrode existing regions 311.

Next, the multilayer sheet is pressed in the height direction by, for example, hydrostatic pressing to prepare a multilayer block.

Next, the multilayer block is cut to a predetermined size and divided into individual pieces to obtain a plurality of multilayer chips. Thereafter, the multilayer chips may be polished by, for example, barrel polishing or the like to round the corner portions and the ridge portions.

Next, the multilayer chips are fired. The multilayer body is manufactured by this firing. The preferable firing temperature is, for example, about 900° C. or higher and about 1400° C. or lower. The firing temperature can be changed according to the materials of the dielectric and the internal electrode layers.

Here, by shortening the firing time, the continuity of the inner-side internal electrode layers 302 can be increased.

The electrically conductive paste defining and functioning as the base electrode layer 50 is applied to both end surfaces of the multilayer body 2. In the present example embodiment, the base electrode layer 50 is a fired layer. The fired layer can be formed by, for example, applying an electrically conductive paste including a glass component and a metal to the multilayer body 2 by a method such as dipping, for example, and then performing firing treatment. The temperature of the firing treatment at this time is, for example, preferably about 700° C. or higher and about 900° C. or lower.

Furthermore, the multilayer chips before firing and the electrically conductive paste applied to the multilayer chip may be fired simultaneously. In such a case, the fired layer is preferably formed by firing a ceramic material added instead of the glass component. At this time, it is preferable to use, as the ceramic material to be added, the same type of ceramic material as the dielectric layer 20. In this case, an electrically conductive paste is applied to the multilayer chip before firing, and the multilayer chip and the electrically conductive paste applied to the multilayer chip are fired at the same time to form the multilayer body 2 in which the fired layer is formed.

Thereafter, the plated layer is formed on the surface of the base electrode layer 50 including the fired layer. In the present example embodiment, the first plated layer 71 is formed on the surface of the first base electrode layer 51. The second plated layer 72 is formed on the surface of the second base electrode layer 52. In the present example embodiment, for example, the nickel plated layer and the tin plated layer are formed as the plated layers. Upon performing the plating process, for example, electrolytic plating or electroless plating may be used. However, electroless plating has a disadvantage in that a pretreatment with a catalyst or the like is necessary in order to improve the plating deposition rate, and thus the process is complicated. Therefore, normally, electrolytic plating is preferably used. The nickel plated layer and the tin plated layer are sequentially formed, for example, by barrel plating.

When providing an electrically conductive resin layer, the electrically conductive resin layer may be provided to cover the fired layer. When providing an electrically conductive resin layer, an electrically conductive resin paste including a thermosetting resin and a metal component is applied on the fired layer, and then heat treatment is performed, for example, at a temperature from about 250 degrees to about 550 degrees or higher. The thermosetting resin is thereby thermally cured to form the electrically conductive resin layer. The atmosphere during this heat treatment is, for example, preferably an N₂ atmosphere. In order to prevent scattering of the resin and to prevent oxidation of various metal components, the oxygen concentration is, for example, preferably about 100 ppm or less.

The multilayer ceramic capacitor 1 is manufactured by the manufacturing steps described above.

The present invention is not limited to the configurations of the example embodiments described above, and can be appropriately modified and applied without changing the scope of the present invention. The present invention also includes combinations of two or more of the individual configurations described in the example embodiments described above.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a plurality of dielectric layers and a plurality of internal electrode layers that are laminated, a first main surface and a second main surface opposed to each other in a height direction, a first lateral surface and a second lateral surface opposed to each other in a width direction orthogonal or substantially orthogonal to the height direction, a first end surface and a second end surface opposed to each other in a length direction orthogonal or substantially orthogonal to the height direction and the width direction, an inner layer portion in which the plurality of dielectric layers and the plurality of internal electrode layers are alternately laminated, and outer layer portions sandwiching the inner layer portion between the first main surface and the second main surface;
a first external electrode on the first end surface; and
a second external electrode on the second end surface;
wherein
when an internal electrode layer of the plurality of internal electrode layers closest to one of the outer layer portions is defined as an outermost internal electrode layer, in a cross section parallel or substantially parallel to the length direction and the height direction, the outermost internal electrode layer includes an internal electrode existing region and an internal electrode dividing region;
the internal electrode dividing region includes a segregated region of magnesium or manganese; and
a ratio B/A of a distance B in the length direction of the segregated region of magnesium or manganese relative to a distance A in the length direction of the internal electrode existing region is about 50% or more and about 75% or less.

2. The multilayer ceramic capacitor according to claim 1, wherein
the internal electrode dividing region includes a non-segregated region where magnesium or manganese is not segregated; and
the distance in the length direction of the segregated region in the internal electrode dividing region is longer than a distance in the length direction of the non-segregated region.

3. The multilayer ceramic capacitor according to claim 1, wherein the multilayer body has a dimension in the length direction of about 0.2 mm or more and about 6 mm or less, a dimension in the height direction of about 0.05 mm or more and about 5 mm or less, and a dimension in the width direction of about 0.1 mm or more and about 5 mm or less.

4. The multilayer ceramic capacitor according to claim 1, wherein each of the plurality of dielectric layers includes barium titanate, calcium titanate, strontium titanate, or calcium zirconate as a main component.

5. The multilayer ceramic capacitor according to claim 4, wherein each of the plurality of dielectric layers includes a manganese compound, an iron compound, a copper compound, a cobalt compound, or a nickel compound as a sub-component.

6. The multilayer ceramic capacitor according to claim 1, wherein a thickness of each of the plurality of dielectric layers is about 0.2 μm or more and about 10 μm or less.

7. The multilayer ceramic capacitor according to claim 1, wherein each of the plurality of internal electrode layers includes nickel, copper, silver, palladium, or gold, or an alloys including at least one of nickel, copper, silver, palladium, or gold.

8. The multilayer ceramic capacitor according to claim 1, wherein a thickness of each of the plurality of internal electrode layers is about 0.2 μm or more and about 2.0 μm or less.

9. The multilayer ceramic capacitor according to claim 1, wherein the internal electrode dividing region includes a plurality of the segregated regions.

10. The multilayer ceramic capacitor according to claim 2, wherein the internal electrode dividing region includes a plurality of the non-segregated regions.

11. The multilayer ceramic capacitor according to claim 9, wherein the distance B is a sum of the distances of the plurality of segregated regions.

12. The multilayer ceramic capacitor according to claim 1, wherein the outermost internal electrode layer includes a plurality of the internal electrode existing regions.

13. The multilayer ceramic capacitor according to claim 12, wherein the distance A is a sum of the distances of the plurality of internal electrode existing regions.
